(19) United States
(12) Patent Application Publication
(10) Pub. No.: US 2019/0014789 A1
(43) Pub. Date: Jan. 17, 2019

(54) STICK-SHAPED BAKED CONFECTIONERY AND METHOD FOR MANUFACTURING SAME

(71) Applicant: EZAKI GLICO CO., LTD., Osaka-shi, Osaka (JP)

(72) Inventors: Hiroaki NAKAMURA, Osaka-shi, Osaka (JP); Seiji HOSOKAWA, Osaka-shi, Osaka (JP); Shinsuke KISE, Osaka-shi, Osaka (JP); Ryoichi IRIE, Osaka-shi, Osaka (JP)

(73) Assignee: EZAKI GLICO CO., LTD., Osaka-shi, Osaka (JP)

(21) Appl. No.: 15/551,279

(22) PCT Filed: Feb. 17, 2016
(86) PCT No.: PCT/JP2016/054587

§ 371 Date: Aug. 15, 2017

(30) Foreign Application Priority Data
Feb. 20, 2015 (JP) 2015-032223

(51) Int. Cl. A21D 13/40; A21D 13/24; A21D 2/36

(52) U.S. Cl. CPC A21D 13/40; A21D 2/36; A21D 2/364; A21D 13/24

(57) ABSTRACT

The present invention provides a stick-shaped baked confectionery resulting from molding of a dough containing 15 to 80 parts by mass of a taste material, 5 to 45 parts by mass of vital gluten, and 0.15 to 1.7 parts by mass of an emulsifier, per 100 parts by mass of at least one member selected from the group consisting of starch and wheat flour into sticks, and baking the dough, wherein the taste material is at least one member selected from the group consisting of cocoa powder, potato granules, nut powder, wheat bran, coffee, powdered green tea, black tea, rice flour, corn powder, whole wheat flour, foxtail millet, barnyard millet, Panicum miliaceum, amaranth and fruit materials, and the emulsifier comprises at least one member selected from the group consisting of sucrose fatty acid esters having an HLB of 11 to 20 and polyglyceryl fatty acid esters having an HLB of 11 to 20.

### TECHNICAL FIELD

The present invention relates to a stick-shaped baked confectionery having a rich-flavor of the material, and a production method thereof.

### BACKGROUND ART

A stick-shaped baked confectionery containing a taste material kneaded therein to add the flavor of the material has been known. For example, Patent Document 1 discloses producing a baked confectionery by kneading cocoa powder into a starch-containing dough, and Patent Document 2 discloses producing a baked confectionery by baking a dough containing rice flour and starch. However, these confectioneries have a problematic distinctive starch odor and glass-like texture.

### CITATION LIST

### Patent Documents

Patent Document 1: JP2003-284501

Patent Document 2: JP2009-232701

### SUMMARY OF INVENTION

### Technical Problem

An object of the present invention is to provide a stick-shaped baked confectionery having a rich-flavor of the material and desirable texture, as well as sufficient strength and crunchiness; and a method for producing the confectionery.

### Solution to Problem

The present invention provides stick-shaped baked confectioneries and a production method thereof, as detailed below.

Item 1. A stick-shaped baked confectionery resulting from molding of a dough containing 15 to 80 parts by mass of a taste material, 5 to 45 parts by mass of vital gluten, and 0.15 to 1.7 parts by mass of an emulsifier, per 100 parts by mass of at least one member selected from the group consisting of starch and wheat flour into sticks, and baking the dough, wherein the taste material is at least one member selected from the group consisting of cocoa powder, potato granules, nut powder, wheat bran, coffee, powdered green tea, black tea, rice flour, corn powder, whole wheat flour, foxtail millet, barnyard millet, Panicum miliaceum, amaranth and fruit materials, and the emulsifier comprises at least one member selected from the group consisting of sucrose fatty acid esters having an HLB of 11 to 20 and polyglyceryl fatty acid esters having an HLB of 11 to 20.
Item 2. The stick-shaped baked confectionery according to Item 1, wherein the taste material is at least one member selected from the group consisting of cocoa powder, potato granules, nut powder, wheat bran, coffee, powdered green tea and black tea; and the amount of the taste material is 15 to 25 parts by mass, and the amount of the vital gluten is 5 to 25 parts by mass, per 100 parts by mass of the at least one member selected from the group consisting of starch and wheat flour; and a ratio (amount of the taste material)/(amount of the vital gluten)=0.5 to 3 is satisfied.
Item 3. The stick-shaped baked confectionery according to Item 1, wherein the taste material is at least one member selected from the group consisting of rice flour, corn powder, whole wheat flour, foxtail millet, barnyard millet, Panicum miliaceum, and amaranth; and the amount of the taste material is 50 to 80 parts by mass, and the amount of the vital gluten is 20 to 45 parts by mass, per 100 parts by mass of the at least one member selected from the group consisting of starch and wheat flour; and a ratio (amount of the taste material)/(amount of the vital gluten)=1.2 to 3 is satisfied.
Item 4. The stick-shaped baked confectionery according to Item 1, wherein the taste material is a fruit material; and the amount of the solids content of the taste material is 15 to 45 parts by mass, and the amount of the vital gluten is 7 to 25 parts by mass, per 100 parts by mass of the at least one member selected from the group consisting of starch and wheat flour; and a ratio (amount of the taste material)/(amount of the vital gluten)=0.5 to 3 is satisfied.
Item 5. The stick-shaped baked confectionery according to Item 4, wherein the fruit material is concentrated juice.
Item 6. The stick-shaped baked confectionery according to Item 1 or 2, wherein the taste material is cocoa powder, and the stick-shaped baked confectionery has a chocolate-coating layer.
Item 7. The stick-shaped baked confectionery according to any one of Items 1 to 6, wherein oil containing a seasoning and/or a flavor is applied to the baked confectionery after baking.
Item 8. A method for producing the stick-shaped baked confectionery according to any one of Items 1 to 7, comprising a step of obtaining a dough by kneading a mixture material containing 15 to 80 parts by mass of a taste material, 5 to 45 parts by mass of vital gluten, and 0.15 to 1.7 parts by mass of an emulsifier, and 20 to 90 parts by mass of water, per 100 parts by mass of at least one member selected from the group consisting of starch and wheat flour; a step of molding the dough into sticks; and a step of baking the resulting stick-shaped dough.

### Advantageous Effects of Invention

In the present invention, appropriate flexibility and softness can be imparted to the dough by adding vital gluten, thereby incorporating a taste material in a greater amount than that in previous products. Further, by adding an emulsifier, water absorption of the taste material over time can be inhibited; as a result, adequate moldability can be stably maintained.

Further, by kneading the taste material into the dough, a rich flavor can be exhibited, thereby achieving stable mass production without requiring a large facility, while reducing the processing cost.

Further, since a porous tissue can be formed by adding vital gluten, a crispy, pleasing texture can be obtained. Further, since the tissue strength can also be enhanced, breakage of the stick-shaped baked confectionery during the distribution can be prevented.

### DESCRIPTION OF EMBODIMENTS

In the present invention, “a stick-shaped baked confectionery” designates a confectionery obtained by molding a dough into sticks, followed by baking. A “dough” designates a block-like object obtained by mixing ingredients and water. The ingredients of dough include at least one member selected from the group consisting of starch and wheat flour, a taste material, vital gluten, and an emulsifier. The at least one member selected from the group consisting of starch and wheat flour has the largest content (the major ingredient). The dough may also contain sugars such as sugar, isomerized sugar, trehalose, palatinose, sugar alcohols, or sweeteners (such as acesulfame potassium or sucralose); edible oils such as shortening, margarine, butter, lard, corn oil, olive oil, cottonseed oil, rapeseed oil, soybean oil, coconut oil, sesame oil, sunflower oil, safflower oil, salad oil, or powdered fat; common salt; dairy products; egg products; yeasts; enzymes; leavening agents such as sodium bicarbonate; seasonings; and the like.

Generally, the starch is not particularly limited, and any commercially available starch may be used. For example, potato starch, tapioca starch, waxy corn starch, glutinous rice starch/rice starch, sweet potato starch, wheat starch, and arrowroot starch and the like may be used. These starch examples may be used in their native state, or after being processed. Examples of processing methods include esterification, etherification, cross-linking treatment, acid treatment, oxidation treatment, heat-moisture treatment, and a combination of these treatments. The denatured or native starch may be used solely, or in combination. The starch of “at least one member selected from the group consisting of starch and wheat flour” designates β-starch. Although gelatinized starch may also be incorporated, gelatinized starch does not correspond to the starch of “at least one member selected from the group consisting of starch and wheat flour.”

Generally, any commercially available wheat flours may be used as the wheat flour; for example, any of hard flour, semi-hard flour, medium-strength flour, and soft flour may be used. The protein content and gluten content are different depending on the type of wheat flour; however, the difference does not affect the amount of vital gluten.

The taste material is at least one member selected from the group consisting of cocoa powder, potato granules, nut powder, wheat bran, coffee, powdered green tea, black tea, rice flour, corn powder, whole-wheat flour, foxtail millet, barnyard millet, Panicum miliaceum, amaranth, and fruit materials. When the taste material is selected from cocoa powder, potato granules, nut powder, wheat bran, coffee, powdered green tea, black tea, rice flour, corn powder, whole-wheat flour, foxtail millet, barnyard millet, Panicum miliaceum, and amaranth, any starch and wheat flour may be used in any proportion. However, when the taste material is a fruit material, starch is more preferable than wheat flour. The starch is more preferably tapioca starch or processed tapioca starch, further preferably processed tapioca starch, particularly preferably acid-treated processed tapioca starch, most preferably acetic acid-treated processed tapioca starch.

Examples of fruit materials include concentrated juice, squeezed juice, single strength juice, peel (fruit skin), puree, and dried fruits. The fruit material is preferably concentrated juice. The squeezed juice refers to an extract obtained by pulverizing a fruit, subjecting it to squeezing, straining, or the like, and then removing skin, seed, and the like from the resulting juice. The concentrated juice refers to a fluid obtained by concentrating squeezed juice; a fluid obtained by concentrating squeezed juice and adding thereto squeezed juice, concentrated squeezed juice, or single strength juice; or a fluid obtained by further adding to the fluid sugars, honeys, or the like. Examples of the concentrated juice include those defined by the Japanese Agricultural Standard. The single strength juice refers to a fluid obtained by diluting concentrated juice. Examples of the concentrated juice and the single strength juice include those defined by the Japanese Agricultural Standard.

Examples of the fruit include orange, satsuma orange, grapefruit, apple, grape, pineapple, peach, summer orange, hassaku orange, iyokan orange, ponkan orange, Citrus depressa, Japanese pear, European pear, persimmon, plum, apricot, cranberry, banana, papaya, kiwifruit, guava, passion fruit, strawberry, watermelon, biwa, muscat, fig, lemon, lime, ume, kabosu (Citrus sphaerocarpa), and melon.

When a material having a strong influence on the property change of the dough, such as cocoa powder, potato granules, nut powder, wheat bran, coffee, powdered green tea, or black tea, is used as a taste material, the amount of the taste material is preferably about 15 to 25 parts by mass, per 100 parts by mass of the at least one member selected from the group consisting of starch and wheat flour. When a material having a weak influence on the property change of the dough, such as rice flour, corn powder, whole-wheat flour, foxtail millet, barnyard millet, Panicum miliaceum, or amaranth is used as a taste material, the amount of the taste material is preferably about 15 to 80 parts by mass, per 100 parts by mass of the at least one member selected from the group consisting of starch and wheat flour. If a rich-flavor taste material is necessary, the amount is more preferably about 50 to 80 parts by mass, most preferably about 55 to 80 parts by mass. When a fruit material is used as the taste material, in order to obtain a sufficient fruitiness, the solids content amount of the taste material is preferably about 15 to 45 parts by mass, per 100 parts by mass of the at least one member selected from the group consisting of starch and wheat flour.

When the taste material is at least one member selected from the group consisting of cocoa powder, potato granules, nut powder, wheat bran, coffee, powdered green tea, black tea, and fruit materials, the ratio between the amount of the taste material and the amount of the vital gluten is preferably such that: (amount of the taste material)/(amount of the vital gluten)=0.5 to 3. When the taste material is at least one member selected from the group consisting of rice flour, corn powder, whole-wheat flour, foxtail millet, barnyard millet, Panicum miliaceum, and amaranth, the ratio between the amount of the taste material and the amount of the vital gluten is preferably such that: (amount of the taste material)/(amount of the vital gluten)=1.2 to 3. The ratio is more preferably 1.3 to 3, further preferably 1.4 to 3. If the ratio is more than 3, the baked product has a dense tissue, and a tough, crunchy texture.

When a material having a strong influence on the property change of the dough and a material having a weak influence on the property change of the dough are mixed, a person skilled in the art can easily set a suitable amount according to the amount specified above.

The vital gluten refers to a gluten having a powdery state, which is rapidly returned to the original viscoelastic gluten by being mixed with water. Examples of drying methods for obtaining vital gluten include flash-drying, spray-drying, vacuum-drying, and freeze-drying. Any of these methods may be used to obtain vital gluten. When the taste material is selected from cocoa powder, potato granules, nut powder, wheat bran, coffee, powdered green tea, black tea, rice flour, corn powder, whole-wheat flour, foxtail millet, barnyard millet, Panicum miliaceum, and amaranth, vital gluten produced by spray-drying or flash-drying is preferable. When the taste material is a fruit material, vital gluten produced by flash-drying (in particular, acid-resistant-type vital gluten produced by flash-drying) is preferable. Examples of commercially available vital gluten include A-glu K (Glico Nutrition Co., Ltd., spray-dried gluten), A-glu RS (Glico Nutrition Co., Ltd., spray-dried gluten), A-glu WP (Glico Nutrition Co., Ltd., flash-dried gluten), KS-700 and V-75 (both are acid-resistant flash-dried gluten, Glico Nutrition Co., Ltd.). The amount of the vital gluten is about 5 to 45 parts by mass.

In a preferred embodiment of the present invention, when a material having a strong influence on the property change of the dough, such as cocoa powder, potato granules, nut powder, wheat bran, coffee, powdered green tea, or black tea, is used as a taste material in an amount of about 15 to 25 parts by mass, per 100 parts by mass of the at least one member selected from the group consisting of starch and wheat flour, the amount of the vital gluten is preferably about 5 to 25 parts by mass, more preferably about 5 to 20 parts by mass.

When a material having a weak influence on the property change of the dough, such as rice flour, corn powder, whole-wheat flour, foxtail millet, barnyard millet, Panicum miliaceum, or amaranth, is used as the taste material in an amount of about 50 to 80 parts by mass, per 100 parts by mass of the at least one member selected from the group consisting of starch and wheat flour, the amount of vital gluten is preferably about 20 to 45 parts by mass.

When a fruit material having a relatively large influence on the property change of the dough is used as the taste material in an amount (solids content) of about 15 to 45 parts by mass, per 100 parts by mass of the at least one member selected from the group consisting of starch and wheat flour, the amount of vital gluten is preferably about 7 to 25 parts by mass, more preferably about 10 to 25 parts by mass.

The emulsifier includes at least one member selected from the group consisting of sucrose fatty acid esters and polyglyceryl fatty acid esters. The sucrose fatty acid esters and the polyglyceryl fatty acid esters preferably have an HLB value of 11 to 20, more preferably an HLB value of 11 to 19. When the emulsifier contains one or both of a sucrose fatty acid ester having an HLB of 11 to 20 or an HLB of 11 to 19, and a polyglyceryl fatty acid ester having an HLB of 11 to 20 or an HLB of 11 to 19, other emulsifiers may also be contained. Examples of other emulsifiers include a (poly)glycerin fatty acid ester having an HLB of 2 to 7. When the taste material is selected from cocoa powder, potato granules, nut powder, wheat bran, coffee, powdered green tea, black tea, rice flour, corn powder, whole-wheat flour, foxtail millet, barnyard millet, Panicum miliaceum, and amaranth, the emulsifier is preferably at least one member selected from the group consisting of sucrose fatty acid esters having an HLB of 11 to 20 or an HLB of 11 to 19, and polyglyceryl fatty acid esters having an HLB of 11 to 20 or an HLB of 11 to 19. When a fruit material is used as the taste material, a sucrose fatty acid ester having an HLB of 11 to 20 or an HLB of 11 to 19 is used; preferably, a combination of a sucrose fatty acid ester having an HLB of 11 to 20 or an HLB of 11 to 19 and a glycerin fatty acid ester having an HLB of 2 to 7 is used. The amount of the emulsifier is preferably about 0.15 to 1.7 parts by mass, per 100 parts by mass of the at least one member selected from the group consisting of starch and wheat flour. When the taste material is selected from cocoa powder, potato granules, nut powder, wheat bran, coffee, powdered green tea, black tea, rice flour, corn powder, whole-wheat flour, foxtail millet, barnyard millet, Panicum miliaceum, and amaranth, the amount of the emulsifier is preferably about 0.15 to 0.6 parts by mass, per 100 parts by mass of the at least one member selected from the group consisting of starch and wheat flour. When a fruit material is used as the taste material, the amount of the emulsifier is preferably about 0.15 to 1.7 parts by mass, more preferably about 0.3 to 1.5 parts by mass, per 100 parts by mass of the at least one member selected from the group consisting of starch and wheat flour.

The stick-shaped baked confectionery of the present invention may be provided with a chocolate-coating layer by applying chocolate to the baked confectionery after baking. It is also possible to apply oil optionally containing seasonings, flavors, and the like to the baked confectionery after baking, thereby improving the flavor. Examples of the oils to be applied include seasoning oils. Examples of oils to be applied also include vegetable oils and fats such as corn oil, olive oil, cottonseed oil, rapeseed oil, soybean oil, coconut oil, sesame oil, sunflower oil, safflower oil, or salad oil; and animal oils and fats such as shortening, margarine, butter, or lard. It is also possible to add a granular material, such as granulated sugar or salt, to the surface of unbaked dough, followed by baking, thereby improving the flavor.

The chocolate coating or the oil coating is performed by a usual method. For example, the coating of the baked confectionery may be performed through a method in which one end of the baked confectionery is pinched with a clip or the like, and the other end is immersed in chocolate or oil accumulated in a container. Another coating method may be an enrober method in which a continuous curtain of chocolate or oil is dropped onto baked confectioneries arranged on a conveyor, thereby applying the chocolate or oil. The oil coating may be performed, for example, by spraying oil to baked confectioneries, and uniformizing the coating as necessary by rotation-stirring using a tumbler or the like.

The stick-shaped baked confectionery may be obtained by molding a dough into sticks, followed by baking. The dough is obtained by mixing about 20 to 90 parts by mass of water, about 15 to 80 parts by mass of a taste material, about 5 to 45 parts by mass of a vital gluten, and about 0.15 to 1.7 parts by mass of an emulsifier, per 100 parts by mass of at least one member selected from the group consisting of starch and wheat flour, together, as necessary, with other components (sugars, edible oils and fats, common salt, dairy products, egg products, yeasts, enzymes, leavening agents, seasonings, etc.), and evenly kneading the mixture into a sheet and molding the sheet into sticks, followed by baking. It is also possible to immerse the stick-shaped dough in an alkaline solution such as trisodium phosphate, followed by baking.

In the production method of the present invention, the dough is molded into sticks in an arbitrary method. For example, the dough is molded into a sheet, and then cut into sticks. In a preferable embodiment, a mixed dough of a stick-shaped baked confectionery is rolled into a sheet having a thickness of 3 to 10 mm, and cut into 3 to 15 mm-thick noodles; thereafter, the lengths of the noodles are equalized to about 50 to 150 mm. The stick-shaped dough is baked under known arbitrary baking conditions, and in an arbitrary method. For example, baking may be performed in a fixed batch oven or in a continuous tunnel oven. When a batch oven is used, baking is performed at about 200° C. for about 10 to 20 minutes; when a tunnel oven is used, baking is performed at 300 to 100° C. for about 5 to 15 minutes, so that the moisture becomes 2% or less.

### EXAMPLES

The present invention is more specifically explained below in reference to Examples and Comparative Examples. Further, in the Tables, the unit of the values is part by mass.

A flash-dried gluten having excellent acid resistance was used in all of the Examples.

### (I) Examples and Comparative Examples Regarding Baked Confectioneries Containing Cocoa Powder, Potato Granules, Nut Powder, or Wheat Bran

### Examples I-1 to I-13 and Comparative Examples I-1 to I-14

Stick-shaped baked confectioneries were made through sheet-molding by mixing ingredients according to the formulations shown in Tables I-1 to I-5 by a standard method to obtain doughs. Each dough was left unattended for 90 minutes at room temperature, and, using a roll, rolled into a sheet having a thickness of 2.5 mm. Subsequently, the sheet was cut into noodle-like shapes having a width of 3.7 mm; thereafter, the lengths were equalized to 120 mm. Subsequently, the noodle-like dough was immersed in trisodium phosphate 6% solution for 3 seconds, followed by baking for 6 minutes in a tunnel oven at 300° C. to 100° C. until the moisture was 1.5%.

TABLE 1
Table I-1: Cacao included

| | Amount in dough (Parts by mass) | | | | |
|---|---|---|---|---|---|
| | Comparative | | | Comparative | Comparative |
| Material name | Example I-1 | Example I-1 | Example I-2 | Example I-2 | Example I-3 |
| Wheat flour (Hard flour) | 100 | 100 | 100 | 100 | 100 |
| Cocoa powder | 12 | 15 | 25 | 28 | 28 |
| Vital gluten | 15 | 15 | 15 | 15 | 15 |
| Sugar | 12 | 12 | 12 | 12 | 20 |
| Shortening | 7 | 7 | 7 | 7 | 7 |
| Sodium bicarbonate | 0.9 | 0.9 | 0.9 | 0.9 | 0.9 |
| Common salt | 0.7 | 0.7 | 0.7 | 0.7 | 0.7 |
| Sucrose fatty acid ester | 0.3 | 0.3 | 0.3 | 0.3 | 0.3 |
| (HLB 15) | | | | | |
| Enzyme | Appropriate | Appropriate | Appropriate | Appropriate | Appropriate |
| | quantity | quantity | quantity | quantity | quantity |
| Water | 40 | 40 | 40 | 40 | 40 |
| Concentration of trisodium | 6% | 6% | 6% | 6% | 6% |
| phosphate solution | | | | | |
| Taste material (Solids | 0.8 | 1.0 | 1.67 | 1.87 | 1.87 |
| content)/Vital gluten | | | | | |
| Evaluation (Molding) | ◯ | ◯ | ◯ | Δ | X |
| | Good | Good | Good | Sheet breaks | Sheet is sticky |
| | | | | relatively | and breaks |
| | | | | easily | relatively |
| | | | | | easily |
| Evaluation (Baked product) | X | ◯ | ◯ | X | Δ |
| | Relatively | Good | Good | Strong cacao | Strong cacao |
| | weak cacao | | | flavor, but | flavor, but |
| | flavor | | | bitter and | relatively hard |
| | | | | mealy | and tough, |
| | | | | | crunchy texture |

The baked confectioneries in Examples I-1 and I-2 had good moldability, and the baked products had a crispy texture and a rich cacao flavor. Further, they had desirable melt-in-the-mouth feeling; additionally, the savory, toasted flavor and cacao flavor were enhanced.

The baked confectioneries in Comparative Example I-1 had good moldability; however, the cacao flavor was insufficient.

Regarding the baked confectionery in Comparative Example I-2, when the dough was rolled, the sheet broke relatively easily; moreover, although it had a strong cacao flavor, it also had bitterness and a mealy flavor.

Regarding the baked confectionery in Comparative Example I-3, when the dough was rolled, the sheet broke relatively easily; moreover, the dough was sticky, and the molding was difficult.

TABLE 2
Table I-2: Cacao included (Amount of Cocoa powder:
Minimum amount ensuring rich cacao flavor)

| | Amount in dough (Parts by mass) | | | | |
|---|---|---|---|---|---|
| | Comparative | | | | Comparative |
| Material name | Example I-4 | Example I-3 | Example I-4 | Example I-5 | Example I-5 |
| Wheat flour (Hard flour) | 100 | 100 | 100 | 100 | 100 |
| Cocoa powder | 15 | 15 | 15 | 15 | 15 |
| Vital gluten | 4 | 5 | 20 | 25 | 26 |
| Sugar | 12 | 12 | 12 | 12 | 12 |
| Shortening | 7 | 7 | 7 | 7 | 7 |
| Sodium bicarbonate | 0.9 | 0.9 | 0.9 | 0.9 | 0.9 |
| Common salt | 0.7 | 0.7 | 0.7 | 0.7 | 0.7 |
| Sucrose fatty acid ester | 0.3 | 0.3 | 0.3 | 0.3 | 0.3 |
| (HLB 15) | | | | | |
| Enzyme | Appropriate | Appropriate | Appropriate | Appropriate | Appropriate |
| | quantity | quantity | quantity | quantity | quantity |
| Water | 40 | 40 | 40 | 40 | 40 |
| Concentration of trisodium | 6% | 6% | 6% | 6% | 6% |
| phosphate solution | | | | | |
| Taste material (Solids | 3.75 | 3.0 | 0.75 | 0.6 | 0.58 |
| content)/Vital gluten | | | | | |
| Evaluation (Molding) | Δ | ◯ | ◯ | ◯ | ◯ |
| | Sheet breaks | Good | Good | Good | Good |
| | relatively | | | | |
| | easily | | | | |
| Evaluation (Baked product) | Δ | ◯ | ◯ | ◯ | X |
| | Relatively | Good | Good | Good | Gluten odor |
| | dense tissue | | | | |

In the baked confectionery in Comparative Example I-4, when the dough was rolled, the sheet broke relatively easily, and the noodle-making was difficult. Further, the tissue after baking was relatively dense.

The baked confectionery in Comparative Example I-5 had a distinctive gluten odor; further, the intrinsic flavor of cacao was diminished.

TABLE 3
Table I-3: Cacao included (Amount of Cocoa powder: Maximum
amount not affecting dough property or taste)

| | Amount in dough (Parts by mass) | | | | |
|---|---|---|---|---|---|
| | Comparative | | | Comparative | Comparative |
| Material name | Example I-6 | Example I-6 | Example I-7 | Example I-7 | Example I-8 |
| Wheat flour (Hard flour) | 100 | 100 | 100 | 100 | 100 |
| Cocoa powder | 25 | 25 | 25 | 25 | 25 |
| Vital gluten | 8 | 13 | 25 | 28 | 31 |
| Sugar | 12 | 12 | 12 | 12 | 12 |
| Shortening | 7 | 7 | 7 | 7 | 7 |
| Sodium bicarbonate | 0.9 | 0.9 | 0.9 | 0.9 | 0.9 |
| Common salt | 0.7 | 0.7 | 0.7 | 0.7 | 0.7 |
| Sucrose fatty acid ester | 0.3 | 0.3 | 0.3 | 0.3 | 0.3 |
| (HLB 15) | | | | | |
| Enzyme | Appropriate | Appropriate | Appropriate | Appropriate | Appropriate |
| | quantity | quantity | quantity | quantity | quantity |
| Water | 40 | 40 | 40 | 40 | 40 |
| Concentration of trisodium | 6% | 6% | 6% | 6% | 6% |
| phosphate solution | | | | | |
| Taste material (Solids | 3.13 | 1.92 | 1.0 | 0.89 | 0.81 |
| content)/Vital gluten | | | | | |
| Evaluation (Molding) | Δ | ◯ | ◯ | Δ | X |
| | Sheet breaks | Good | Good | Relatively | Hard dough |
| | relatively | | | hard dough | and rough |
| | easily | | | | skin of sheet |
| Evaluation (Baked product) | Δ | ◯ | ◯ | Δ | X |
| | Relatively | Good | Good | Relatively | Hard and |
| | dense tissue | | | hard texture | tough, |
| | | | | | crunchy |
| | | | | | texture, and |
| | | | | | Gluten odor |

Regarding the baked confectioneries in Comparative Example I-6, when the dough was rolled, the sheet broke relatively easily, and the noodle-making was difficult. Further, the tissue after baking was relatively dense.

Regarding the baked confectionery in Comparative Example I-7, the dough was relatively hard; and, after baking, the baked product had a relatively hard and tough, crunchy texture.

Regarding the baked confectionery in Comparative Example I-8, the dough was hard, and the sheet was prone to have rough skin on the surface. Further, after baking, it had a hard and tough, crunchy texture and distinctive gluten odor; moreover, the intrinsic flavor of cacao was diminished.

TABLE 4
Table I-4: Cacao included

| | Amount in dough (Parts by mass) | | | |
|---|---|---|---|---|
| | Comparative | | | Comparative |
| Material name | Example I-9 | Example I-8 | Example I-9 | Example I-10 |
| Wheat flour (Hard flour) | 100 | 100 | 100 | 100 |
| Cocoa powder | 20 | 20 | 20 | 20 |
| Vital gluten | 15 | 15 | 15 | 15 |
| Sugar | 12 | 12 | 12 | 12 |
| Shortening | 7 | 7 | 7 | 7 |
| Sodium bicarbonate | 0.9 | 0.9 | 0.9 | 0.9 |
| Common salt | 0.7 | 0.7 | 0.7 | 0.7 |
| Sucrose fatty acid ester | 0.1 | 0.15 | 0.6 | 0.65 |
| (HLB 15) | | | | |
| Enzyme | Appropriate | Appropriate | Appropriate | Appropriate |
| | quantity | quantity | quantity | quantity |
| Water | 40 | 40 | 40 | 40 |
| Concentration of trisodium | 6% | 6% | 6% | 6% |
| phosphate solution | | | | |
| Taste material (Solids | 1.33 | 1.33 | 1.33 | 1.33 |
| content)/Vital gluten | | | | |
| Evaluation (Molding) | Δ | ◯ | ◯ | ◯ |
| | Sheet breaks | Good | Good | Good |
| | relatively | | | |
| | easily | | | |
| Evaluation (Baked product) | X | ◯ | ◯ | X |
| | Dense tissue, | Good | Good | Crumbly |
| | and hard and | | | tissue and |
| | tough, crunchy | | | mealy flavor |
| | texture | | | |

Regarding the baked confectionery in Comparative Example I-9, when the dough was rolled, the sheet broke relatively easily; further, it was prone to harden over time. The tissue after baking was dense, and the baked product had a relatively hard and tough, crunchy texture.

The baked confectionery in Comparative Example I-10 had good moldability, but the tissue after baking was crumbly; moreover, the baked product had a mealy flavor and inferior melt-in-the-mouth feeling.

TABLE 5
Table I-5: Cacao included

| | Amount in dough (Parts by mass) | | | | | | | |
|---|---|---|---|---|---|---|---|---|
| | Comparative | Comparative | | | | | | |
| | Example | Example | Comparative | | | Comparative | | Example I- |
| Material name | I-11 | I-12 | Example I-13 | Example I-10 | Example I-11 | Example I-14 | Example I-12 | 13 |
| Wheat flour (Hard | 100 | 100 | 100 | 100 | 100 | 100 | 100 | 100 |
| flour) | | | | | | | | |
| Cocoa powder | 20 | 20 | 20 | 20 | 20 | 20 | 20 | 20 |
| Vital gluten | 15 | 15 | 15 | 15 | 15 | 15 | 15 | 15 |
| Sugar | 12 | 12 | 12 | 12 | 12 | 12 | 12 | 12 |
| Shortening | 7 | 7 | 7 | 7 | 7 | 7 | 7 | 7 |
| Sodium bicarbonate | 0.9 | 0.9 | 0.9 | 0.9 | 0.9 | 0.9 | 0.9 | 0.9 |
| Common salt | 0.7 | 0.7 | 0.7 | 0.7 | 0.7 | 0.7 | 0.7 | 0.7 |
| Sucrose fatty acid | 0.3 | — | — | — | | | | — |
| ester HLB 5 | | | | | | | | |
| Lecithin HLB 5 | — | 0.3 | — | — | | | | — |
| Sucrose fatty acid | — | — | 0.3 | — | | | | — |
| ester HLB 9 | | | | | | | | |
| Sucrose fatty acid | — | — | — | 0.3 | | | | |
| ester HLB 11 | | | | | | | | |
| Sucrose fatty acid | — | — | — | — | 0.3 | | | |
| ester HLB 19 | | | | | | | | |
| Polyglyceryl fatty | — | — | — | — | — | 0.3 | | |
| acid ester HLB 9 | | | | | | | | |
| Polyglyceryl fatty | — | — | — | — | — | — | 0.3 | |
| acid ester HLB 11 | | | | | | | | |
| Polyglyceryl fatty | — | — | — | — | — | — | — | 0.3 |
| acid ester HLB 19 | | | | | | | | |
| Enzyme | Appropriate | Appropriate | Appropriate | Appropriate | Appropriate | Appropriate | Appropriate | Appropriate |
| | quantity | quantity | quantity | quantity | quantity | quantity | quantity | quantity |
| Water | 40 | 40 | 40 | 40 | 40 | 40 | 40 | 40 |
| Concentration of | 6% | 6% | 6% | 6% | 6% | 6% | 6% | 6% |
| trisodium phosphate | | | | | | | | |
| solution | | | | | | | | |
| Taste material (Solids | 1.33 | 1.33 | 1.33 | 1.33 | 1.33 | 1.33 | 1.33 | 1.33 |
| content)/ | | | | | | | | |
| Vital gluten | | | | | | | | |
| Evaluation (Molding) | X | X | Δ | ◯ | ◯ | Δ | ◯ | ◯ |
| Evaluation (Baked | X | X | Δ | ◯ | ◯ | Δ | ◯ | ◯ |
| product) | | | | | | | | |

Regarding the baked confectionery in Comparative Examples I-11 to 13, 14, when the dough was rolled, the sheet easily broke; further, it was prone to harden over time. After baking, the tissue was dense, and the baked product had a hard and tough, crunchy texture.

### (II) Examples and Comparative Examples Regarding Baked Confectioneries Containing Rice Flour and Corn Powder Examples II-1 to II-13 and Comparative Examples II-1 to II-12

Stick-shaped baked confectioneries were made through sheet-molding by mixing ingredients according to the formulations shown in Tables II-1 to II-5 by a standard method to obtain doughs. Each dough was left unattended for 90 minutes at room temperature, and rolled into a sheet having a thickness of 2.5 mm using a roll. Subsequently, the sheet was cut into noodle-like shapes having a width of 3.7 mm; thereafter, the lengths were equalized to 120 mm. Subsequently, the noodle-like dough was immersed in trisodium phosphate 6% solution for 3 seconds, followed by baking for 6 minutes in a tunnel oven at 300° C. to 100° C. until the moisture was 1.5%.

TABLE 6
Table II-1: Rice flour included

| | Amount in dough (Parts by mass) | | | |
|---|---|---|---|---|
| | | | | Comparative |
| Material name | Example II-1 | Example II-2 | Example II-3 | Example II-1 |
| Starch | 100 | 100 | 100 | 100 |
| Rice flour | 50 | 55 | 80 | 85 |
| Vital gluten | 30 | 30 | 30 | 30 |
| Shortening | 17 | 17 | 17 | 17 |
| Sugar | 14 | 14 | 14 | 14 |
| Common salt | 2 | 2 | 2 | 2 |
| Yeast | 1.5 | 1.5 | 1.5 | 1.5 |
| Sucrose fatty acid ester | 0.3 | 0.3 | 0.3 | 0.3 |
| (HLB 15) | | | | |
| Enzyme | Appropriate | Appropriate | Appropriate | Appropriate |
| | quantity | quantity | quantity | quantity |
| Water | 73 | 73 | 73 | 73 |
| Taste material (Solids | 1.67 | 1.83 | 2.67 | 2.83 |
| content)/Vital gluten | | | | |
| Evaluation (Molding) | ◯ | ◯ | ◯ | Δ |
| | Good | Good | Good | Sheet breaks |
| | | | | relatively |
| | | | | easily |
| Evaluation (Baked product) | ◯ | ⊚ | ⊚ | Δ |
| | Good rice | Rich rice | Rich rice | Relatively |
| | flavor | flavor | flavor | crumbly tissue |
| | | | | and mealy flavor |

The baked confectioneries in Examples 11-2 and 11-3 had good moldability, and the baked products had a crispy texture and rich rice flavor. Further, they had a desirable melt-in-the-mouth feeling, and enhanced savory, toasted rice flavor.

The baked confectionery in Example II-1 had a good rice flavor, though it was not rich.

Regarding the baked confectionery in Comparative Example II-1, when the dough was rolled, the sheet broke relatively easily; moreover, although the rice flavor was strong, it had a relatively mealy flavor.

TABLE 7
Table II-2: Rice flour included (Amount of rice
flour: Minimum amount ensuring rich rice flavor)

| | Amount in dough (Parts by mass) | | | |
|---|---|---|---|---|
| | Comparative | | | Comparative |
| Material name | Example II-2 | Example II-4 | Example II-5 | Example II-3 |
| Starch | 100 | 100 | 100 | 100 |
| Rice flour | 55 | 55 | 55 | 55 |
| Vital gluten | 17 | 20 | 40 | 46 |
| Shortening | 17 | 17 | 17 | |
| Sugar | 14 | 14 | 14 | 14 |
| Common salt | 2 | 2 | 2 | 2 |
| Yeast | 1.5 | 1.5 | 1.5 | 1.5 |
| Sucrose fatty acid ester | 0.3 | 0.3 | 0.3 | 0.3 |
| (HLB 15) | | | | |
| Enzyme | Appropriate | Appropriate | Appropriate | Appropriate |
| | quantity | quantity | quantity | quantity |
| Water | 73 | 73 | 73 | 73 |
| Taste material (Solids | 3.23 | 2.75 | 1.38 | 1.19 |
| content)/Vital gluten | | | | |
| Evaluation (Molding) | Δ | ◯ | ◯ | X |
| | Sheet breaks | Good | Good | Hard dough |
| | relatively | | | and rough |
| | easily | | | skin of sheet |
| Evaluation (Baked product) | X | ◯ | ◯ | X |
| | Crumbly | Good | Good | Hard and |
| | tissue and | | | tough, |
| | mealy flavor | | | crunchy |
| | | | | texture, |
| | | | | Gluten odor |

Regarding the baked confectionery in Comparative Example II-2, when the dough was rolled, the sheet broke relatively easily, and the noodle-making was difficult. Further, the tissue after baking was crumbly, and it had a mealy flavor and inferior melt-in-the-mouth feeling.

Regarding the baked confectionery in Comparative Example II-3, the dough was hard, and the sheet was prone to have rough skin on the surface. After baking, it had a hard, tough, crunchy texture and distinctive gluten odor; further, the rice flavor was diminished.

TABLE 8
Table II-3: Rice flour included (Amount of rice flour:
Maximum amount not affecting dough property or texture)

| | Amount in dough (Parts by mass) | | | | |
|---|---|---|---|---|---|
| | Comparative | | | Comparative | Comparative |
| Material name | Example II-4 | Example II-6 | Example II-7 | Example II-5 | Example II-6 |
| Starch | 100 | 100 | 100 | 100 | 100 |
| Rice flour | 80 | 80 | 80 | 80 | 80 |
| Vital gluten | 22 | 27 | 45 | 48 | 51 |
| Shortening | 17 | 17 | 17 | 17 | 17 |
| Sugar | 14 | 14 | 14 | 14 | 14 |
| Common salt | 2 | 2 | 2 | 2 | 2 |
| Yeast | 1.5 | 1.5 | 1.5 | 1.5 | 1.5 |
| Sucrose fatty acid ester | 0.4 | 0.4 | 0.4 | 0.4 | 0.4 |
| (HLB15) | | | | | |
| Enzyme | Appropriate | Appropriate | Appropriate | Appropriate | Appropriate |
| | quantity | quantity | quantity | quantity | quantity |
| Water | 73 | 73 | 73 | 73 | 73 |
| Taste material (Solids | 3.64 | 2.96 | 1.78 | 1.67 | 1.57 |
| content)/Vital gluten | | | | | |
| Evaluation (Molding) | Δ | ◯ | ◯ | Δ | X |
| | Sheet breaks | Good | Good | Relatively | Hard dough |
| | relatively | | | hard dough | and rough |
| | easily | | | | skin of sheet |
| Evaluation (Baked product) | X | ◯ | ◯ | Δ | X |
| | Crumbly | Good | Good | Hard and | Hard and |
| | tissue and | | | tough, | tough, |
| | mealy flavor | | | crunchy | crunchy |
| | | | | texture | texture, |
| | | | | | Gluten odor |

Regarding the baked confectionery in Comparative Example II-4, when the dough was rolled, the sheet broke relatively easily, and the noodle-making was difficult. Further, the tissue after baking was crumbly; additionally, it had a mealy flavor and inferior melt-in-the-mouth feeling.

Regarding the baked confectionery in Comparative Example II-5, the dough was relatively hard; further, after baking, it had a hard and tough, crunchy texture.

Regarding the baked confectionery in Comparative Example II-6, the dough was hard, and the sheet was prone to have rough skin on the surface. After baking, it had a hard and tough, crunchy texture and distinctive gluten odor; moreover, the intrinsic flavor of rice was diminished.

TABLE 9
Table II-4: Rice flour included

| | Amount in dough (Parts by mass) | | | |
|---|---|---|---|---|
| | Comparative | | | Comparative |
| Material name | Example II-7 | Example II-8 | Example II-9 | Example II-8 |
| Starch | 100 | 100 | 100 | 100 |
| Rice flour | 70 | 70 | 70 | 70 |
| Vital gluten | 30 | 30 | 30 | 30 |
| Shortening | 17 | 17 | 17 | 17 |
| Sugar | 14 | 14 | 14 | 14 |
| Common salt | 2 | 2 | 2 | 2 |
| Yeast | 1.5 | 1.5 | 1.5 | 1.5 |
| Sucrose fatty acid ester | 0.1 | 0.15 | 0.5 | 0.6 |
| (HLB 15) | | | | |
| Enzyme | Appropriate | Appropriate | Appropriate | Appropriate |
| | quantity | quantity | quantity | quantity |
| Water | 73 | 73 | 73 | 73 |
| Taste material (Solids | 2.33 | 2.33 | 2.33 | 2.33 |
| content)/Vital gluten | | | | |
| Evaluation (Molding) | Δ | ◯ | ◯ | ◯ |
| | Sheet breaks | Good | Good | Good |
| | relatively | | | |
| | easily | | | |
| Evaluation (Baked product) | X | ◯ | ◯ | X |
| | Dense tissue, | Good | Good | Crumbly |
| | and hard and | | | tissue and |
| | tough, crunchy | | | mealy flavor |
| | texture | | | |

Regarding the baked confectioneries in Comparative Example II-7, when the dough was rolled, the dough broke relatively easily; further, it was prone to harden over time. The tissue after baking was dense, and the baked product had a hard and tough, crunchy texture.

The baked confectionery in Comparative Example II-8 had good moldability, but the tissue after baking was crumbly, and it had a mealy flavor and inferior melt-in-the-mouth feeling.

TABLE 10
Table II-5: Rice flour included

| | Amount in dough (Parts by mass) | | | | | | | |
|---|---|---|---|---|---|---|---|---|
| | | Comparative | Comparative | | | Comparative | | |
| | Comparative | Example II- | Example II- | Example II- | | Example II- | Example II- | |
| Material name | Example II-9 | 10 | 11 | 10 | Example II-11 | 12 | 12 | Example II-13 |
| Starch | 100 | 100 | 100 | 100 | 100 | 100 | 100 | 100 |
| Rice flour | 70 | 70 | 70 | 70 | 70 | 70 | 70 | 70 |
| Vital gluten | 30 | 30 | 30 | 30 | 30 | 30 | 30 | 30 |
| Shortening | 17 | 17 | 17 | 17 | 17 | 17 | 17 | 17 |
| Sugar | 14 | 14 | 14 | 14 | 14 | 14 | 14 | 14 |
| Common salt | 2 | 2 | 2 | 2 | 2 | 2 | 2 | 2 |
| Yeast | 1.5 | 1.5 | 1.5 | 1.5 | 1.5 | 1.5 | 1.5 | 1.5 |
| Sucrose fatty acid ester | 0.3 | — | — | — | | | | — |
| HLB5 | | | | | | | | |
| Lecithin HLB5 | — | 0.3 | — | — | | | | — |
| Sucrose fatty acid ester | — | — | 0.3 | — | | | | — |
| HLB9 | | | | | | | | |
| Sucrose fatty acid ester | — | — | — | 0.3 | | | | |
| HLB11 | | | | | | | | |
| Sucrose fatty acid ester | — | — | — | — | 0.3 | | | |
| HLB19 | | | | | | | | |
| Polyglyceryl fatty acid | — | — | — | — | — | 0.3 | | |
| ester HLB9 | | | | | | | | |
| Polyglyceryl fatty acid | — | — | — | — | — | — | 0.3 | |
| ester HLB11 | | | | | | | | |
| Polyglyceryl fatty acid | — | — | — | — | — | — | — | 0.3 |
| ester HLB19 | | | | | | | | |
| Enzyme | Appropriate | Appropriate | Appropriate | Appropriate | Appropriate | Appropriate | Appropriate | Appropriate |
| | quantity | quantity | quantity | quantity | quantity | quantity | quantity | quantity |
| Water | 73 | 73 | 73 | 73 | 73 | 73 | 73 | 73 |
| Taste material (Solids | 2.33 | 2.33 | 2.33 | 2.33 | 2.33 | 2.33 | 2.33 | 2.33 |
| content)/Vital gluten | | | | | | | | |
| Evaluation (Molding) | X | X | Δ | ◯ | ◯ | Δ | ◯ | ◯ |
| Evaluation (Baked product) | X | X | Δ | ◯ | ◯ | Δ | ◯ | ◯ |

Regarding the baked confectioneries in Comparative Examples II-9 to 12, the dough broke easily when the dough was rolled; further, it was prone to harden over time. The tissue after baking was dense, and the baked products had a hard and tough, crunchy texture.

### (III) Examples and Comparative Examples Regarding Baked Confectioneries Containing Fruit Material

### Examples III-1 to III-13 and Comparative Examples III-1 to III-4

Stick-shaped baked confectioneries were made through sheet-molding by mixing ingredients according to the formulations shown in Tables III-1 to III-5 by a standard method to obtain doughs. Each dough was left unattended for 90 minutes at room temperature, and rolled into a sheet having a thickness of 2.5 mm using a roll.

Subsequently, the sheet was cut into noodle-like shapes having a width of 3.7 mm; thereafter, the lengths were equalized to 120 mm. Subsequently, the noodle-like dough was immersed in trisodium phosphate 6% solution for 3 seconds, followed by baking for 6 minutes in a tunnel oven at 300° C. to 100° C. until the moisture was 1.5%.

TABLE 11
Table III-1: Concentrated juice included

Amount in dough (Parts by mass)

| Material name | Example III-1 | Example III-2 |
|---|---|---|
| β-Starch | 100 | 100 |
| Concentrated juice material | 50 | 60 |
| (Solids content) | (35) | (42) |
| Vital gluten | 18 | 18 |
| Gelatinized starch | 17 | 17 |
| Shortening | 15 | 15 |
| Sodium bicarbonate | 0.4 | 0.4 |
| Common salt | 0.4 | 0.4 |
| Sucrose fatty acid ester | 1.0 | 1.0 |
| (HLB 15) | | |
| Polyglyceryl fatty acid ester | 0.15 | 0.15 |
| (HLB 4.5) | | |
| Enzyme | Appropriate | Appropriate |
| | quantity | quantity |
| Water | 35 | 32 |
| Taste material (Solids | 1.94 | 2.33 |
| content)/Vital gluten | | |
| Evaluation (Molding) | ◯ | ◯ |
| | Good | Good |
| Evaluation (Baked product) | ◯ | ◯ |
| | Good | Good |

The baked confectioneries in Examples III-1 and III-2 had good moldability, and the baked products had a crispy texture and rich, juicy feeling. Further, the baked products had a desirable melt-in-the-mouth feeling, and enhanced juicy feeling.

TABLE 12
Table III-2: Concentrated juice included

Amount in dough (Parts by mass)

| Material name | Example III-1 | Example III-2 |
|---|---|---|
| β-Starch | 100 | 100 |
| Concentrated juice material | 50 | 60 |
| (Solids content) | (35) | (42) |
| Vital gluten | 18 | 18 |
| Gelatinized starch | 17 | 17 |
| Shortening | 15 | 15 |
| Sodium bicarbonate | 0.4 | 0.4 |
| Common salt | 0.4 | 0.4 |
| Sucrose fatty acid ester | 1.0 | 1.0 |
| (HLB 15) | | |
| Polyglyceryl fatty acid ester | 0.15 | 0.15 |
| (HLB 4.5) | | |
| Enzyme | Appropriate | Appropriate |
| | quantity | quantity |
| Water | 35 | 32 |
| Taste material (Solids | 1.94 | 2.33 |
| content)/Vital gluten | | |
| Evaluation (Molding) | ◯ | ◯ |
| | Good | Good |
| Evaluation (Baked product) | ◯ | ◯ |
| | Good | Good |

TABLE 13
Table III-3: Concentrated juice included (Amount of concentrated
juice: Amount not affecting dough property or taste)

Amount in dough (Parts by mass)

| Material name | Example III-6 | Example III-7 |
|---|---|---|
| β-Starch | 100 | 100 |
| Concentrated juice material | 60 | 60 |
| (Solids content) | (42) | (42) |
| Vital gluten | 20 | 25 |
| Gelatinized starch | 17 | 17 |
| Shortening | 15 | 15 |
| Sodium bicarbonate | 0.4 | 0.4 |
| Common salt | 0.4 | 0.4 |
| Sucrose fatty acid ester | 1.0 | 1.0 |
| (HLB 15) | | |
| Polyglyceryl fatty acid ester | 0.15 | 0.15 |
| (HLB 4.5) | | |
| Enzyme | Appropriate | Appropriate |
| | quantity | quantity |
| Water | 40 | 45 |
| Taste material (Solids | 2.1 | 1.68 |
| content)/Vital gluten | | |
| Evaluation (Molding) | ◯ | ◯ |
| | Good | Good |
| Evaluation (Baked product) | ◯ | ◯ |
| | Good | Good |

TABLE 14
Table III-4: Concentrated juice included (Maximum amount of Emulsifier)

| | Amount in dough (Parts by mass) | | | |
|---|---|---|---|---|
| | | | | Comparative |
| Material name | Example III-8 | Example III-9 | Example III-10 | Example III-1 |
| β-Starch | 100 | 100 | 100 | 100 |
| Concentrated juice material | 50 | 50 | 50 | 50 |
| (Solids content) | (35) | (35) | (35) | (35) |
| Vital gluten | 18 | 18 | 18 | 18 |
| Gelatinized starch | 17 | 17 | 17 | 17 |
| Shortening | 15 | 15 | 15 | 15 |
| Sodium bicarbonate | 0.4 | 0.4 | 0.4 | 0.4 |
| Common salt | 0.4 | 0.4 | 0.4 | 0.4 |
| Sucrose fatty acid ester | 1.0 | 1.5 | 1.7 | 2.0 |
| (HLB 15) | | | | |
| Polyglyceryl fatty acid ester | 0.15 | 0.15 | 0.15 | 0.15 |
| (HLB 4.5) | | | | |
| Enzyme | Appropriate | Appropriate | Appropriate | Appropriate |
| | quantity | quantity | quantity | quantity |
| Water | 40 | 45 | 40 | 45 |
| Taste material (Solids | 1.94 | 1.94 | 1.94 | 1.94 |
| content)/Vital gluten | | | | |
| Evaluation (Molding) | ◯ | ◯ | ◯ | ◯ |
| | Good | Good | Good | Good |
| Evaluation (Baked product) | ◯ | ◯ | ◯ | X |
| | Good | Good | Good | Crumbly tissue |
| | | | | and mealy flavor |

The baked confectionery in Comparative Example III-1 had good moldability, but the tissue after baking was crumbly; further, it had a mealy flavor and inferior melt-in-the-mouth feeling; moreover, the juicy feeling was weak.

TABLE 15
Table III-5: Concentrated juice included (Consideration of Emulsifier and HLB)

| | Amount in dough (Parts By mass) | | | | | |
|---|---|---|---|---|---|---|
| | Comparative | Comparative Example | Comparative Example | Example III- | Example III- | Example III- |
| Material name | Example III-2 | III-3 | III-4 | 11 | 12 | 13 |
| ß-Starch | 100 | 100 | 100 | 100 | 100 | 100 |
| Concentrated juice | 50 | 50 | 50 | 50 | 50 | 50 |
| material | (35) | (35) | (35) | (35) | (35) | (35) |
| (Solids content) | | | | | | |
| Vital gluten | 18 | 18 | 18 | 18 | 18 | 18 |
| Gelatinized starch | 17 | 17 | 17 | 17 | 17 | 17 |
| Shortening | 15 | 15 | 15 | 15 | 15 | 15 |
| Sodium bicarbonate | 0.4 | 0.4 | 0.4 | 0.4 | 0.4 | 0.4 |
| Common salt | 0.4 | 0.4 | 0.4 | 0.4 | 0.4 | 0.4 |
| Sucrose fatty acid | 1.0 | | | | | |
| ester (HLB 3) | | | | | | |
| Sucrose fatty acid | | 1.0 | | | | |
| ester (HLB 5) | | | | | | |
| Sucrose fatty acid | | | 1.0 | | | |
| ester (HLB 9) | | | | | | |
| Sucrose fatty acid | | | | 1.0 | | |
| ester (HLB 11) | | | | | | |
| Sucrose fatty acid | | | | | 1.0 | |
| ester (HLB 15) | | | | | | |
| Sucrose fatty acid | | | | | | 1.0 |
| ester (HLB 20) | | | | | | |
| Polyglyceryl fatty | 0.15 | 0.15 | 0.15 | 0.15 | 0.15 | 0.15 |
| acid ester | | | | | | |
| (HLB 4.5) | | | | | | |
| Enzyme | Appropriate quantity | Appropriate quantity | Appropriate quantity | Appropriate | Appropriate | Appropriate |
| | | | | quantity | quantity | quantity |
| Water | 35 | 35 | 35 | 35 | 35 | 35 |
| Taste material | 1.94 | 1.94 | 1.94 | 1.94 | 1.94 | 1.94 |
| (Solids | | | | | | |
| content)/Vital gluten | | | | | | |
| Evaluation (Molding) | X | X | X | ◯ | ◯ | ◯ |
| | Sheet breaks and | Sheet breaks and | Sheet breaks and | Good | Good | Good |
| | Significantly changes | Significantly changes | Significantly changes | | | |
| | over time | over time | over time | | | |
| Evaluation (Baked | X | X | X | ◯ | ◯ | ◯ |
| product) | Relatively dense | Relatively dense | Relatively dense | Good | Good | Good |
| | tissue, and hard | tissue, and hard and | tissue, and hard and | | | |
| | and tough, | tough, crunchy texture | tough, crunchy texture | | | |
| | crunchy texture | | | | | |

Regarding the baked confectioneries in Comparative Examples III-2 to III-4, the sheet easily broke when the dough was rolled; further, they were prone to harden over time. The tissue after baking was dense; further, it had a hard and tough, crunchy texture.

1. A stick-shaped baked confectionery resulting from molding of a dough containing 15 to 80 parts by mass of a taste material, 5 to 45 parts by mass of vital gluten, and 0.15 to 1.7 parts by mass of an emulsifier, per 100 parts by mass of at least one member selected from the group consisting of starch and wheat flour into sticks, and baking the dough, wherein the taste material is at least one member selected from the group consisting of cocoa powder, potato granules, nut powder, wheat bran, coffee, powdered green tea, black tea, rice flour, corn powder, whole wheat flour, foxtail millet, barnyard millet, Panicum miliaceum, amaranth and fruit materials, and the emulsifier comprises at least one member selected from the group consisting of sucrose fatty acid esters having an HLB of 11 to 20 and polyglyceryl fatty acid esters having an HLB of 11 to 20.

2. The stick-shaped baked confectionery according to claim 1, wherein the taste material is at least one member selected from the group consisting of cocoa powder, potato granules, nut powder, wheat bran, coffee, powdered green tea and black tea; and the amount of the taste material is 15 to 25 parts by mass, and the amount of the vital gluten is 5 to 25 parts by mass, per 100 parts by mass of the at least one member selected from the group consisting of starch and wheat flour; and a ratio (amount of the taste material)/(amount of the vital gluten)=0.5 to 3 is satisfied.

3. The stick-shaped baked confectionery according to claim 1, wherein the taste material is at least one member selected from the group consisting of rice flour, corn powder, whole wheat flour, foxtail millet, barnyard millet, Panicum miliaceum, and amaranth; and the amount of the taste material is 50 to 80 parts by mass, and the amount of the vital gluten is 20 to 45 parts by mass, per 100 parts by mass of the at least one member selected from the group consisting of starch and wheat flour; and a ratio (amount of the taste material)/(amount of the vital gluten)=1.2 to 3 is satisfied.

4. The stick-shaped baked confectionery according to claim 1, wherein the taste material is a fruit material; and the amount of the solids content of the taste material is 15 to 45 parts by mass, and the amount of the vital gluten is 7 to 25 parts by mass, per 100 parts by mass of the at least one member selected from the group consisting of starch and wheat flour; and a ratio (amount of the taste material)/(amount of the vital gluten)=0.5 to 3 is satisfied.

5. The stick-shaped baked confectionery according to claim 4,
wherein the fruit material is concentrated juice.

6. The stick-shaped baked confectionery according to claim 1, wherein the taste material is cocoa powder, and the stick-shaped baked confectionery has a chocolate-coating layer.

7. The stick-shaped baked confectionery according to claim 1, wherein oil containing a seasoning and/or a flavor is applied to the baked confectionery after baking.

8. A method for producing the stick-shaped baked confectionery according to claim 1, comprising a step of obtaining a dough by kneading a mixture material containing 15 to 80 parts by mass of a taste material, 5 to 45 parts by mass of vital gluten, 0.15 to 1.7 parts by mass of an emulsifier, and 20 to 90 parts by mass of water, per 100 parts by mass of at least one member selected from the group consisting of starch and wheat flour; a step of molding the dough into sticks; and a step of baking the resulting stick-shaped dough.

9. The stick-shaped baked confectionery according to claim 2, wherein the taste material is cocoa powder, and the stick-shaped baked confectionery has a chocolate-coating layer.

10. The stick-shaped baked confectionery according to claim 2, wherein oil containing a seasoning and/or a flavor is applied to the baked confectionery after baking.

11. The stick-shaped baked confectionery according to claim 3, wherein oil containing a seasoning and/or a flavor is applied to the baked confectionery after baking.

12. The stick-shaped baked confectionery according to claim 4, wherein oil containing a seasoning and/or a flavor is applied to the baked confectionery after baking.

13. The stick-shaped baked confectionery according to claim 5, wherein oil containing a seasoning and/or a flavor is applied to the baked confectionery after baking.

14. The stick-shaped baked confectionery according to claim 6, wherein oil containing a seasoning and/or a flavor is applied to the baked confectionery after baking.

15. A method for producing the stick-shaped baked confectionery according to claim 2, comprising a step of obtaining a dough by kneading a mixture material containing 15 to 80 parts by mass of a taste material, 5 to 45 parts by mass of vital gluten, 0.15 to 1.7 parts by mass of an emulsifier, and 20 to 90 parts by mass of water, per 100 parts by mass of at least one member selected from the group consisting of starch and wheat flour; a step of molding the dough into sticks; and a step of baking the resulting stick-shaped dough.

16. A method for producing the stick-shaped baked confectionery according to claim 3, comprising a step of obtaining a dough by kneading a mixture material containing 15 to 80 parts by mass of a taste material, 5 to 45 parts by mass of vital gluten, 0.15 to 1.7 parts by mass of an emulsifier, and 20 to 90 parts by mass of water, per 100 parts by mass of at least one member selected from the group consisting of starch and wheat flour; a step of molding the dough into sticks; and a step of baking the resulting stick-shaped dough.

17. A method for producing the stick-shaped baked confectionery according to claim 4, comprising a step of obtaining a dough by kneading a mixture material containing 15 to 80 parts by mass of a taste material, 5 to 45 parts by mass of vital gluten, 0.15 to 1.7 parts by mass of an emulsifier, and 20 to 90 parts by mass of water, per 100 parts by mass of at least one member selected from the group consisting of starch and wheat flour; a step of molding the dough into sticks; and a step of baking the resulting stick-shaped dough.

18. A method for producing the stick-shaped baked confectionery according to claim 5, comprising a step of obtaining a dough by kneading a mixture material containing 15 to 80 parts by mass of a taste material, 5 to 45 parts by mass of vital gluten, 0.15 to 1.7 parts by mass of an emulsifier, and 20 to 90 parts by mass of water, per 100 parts by mass of at least one member selected from the group consisting of starch and wheat flour; a step of molding the dough into sticks; and a step of baking the resulting stick-shaped dough.

19. A method for producing the stick-shaped baked confectionery according to claim 6, comprising a step of obtaining a dough by kneading a mixture material containing 15 to 80 parts by mass of a taste material, 5 to 45 parts by mass of vital gluten, 0.15 to 1.7 parts by mass of an emulsifier, and 20 to 90 parts by mass of water, per 100 parts by mass of at least one member selected from the group consisting of starch and wheat flour; a step of molding the dough into sticks; and a step of baking the resulting stick-shaped dough.

20. A method for producing the stick-shaped baked confectionery according to claim 7, comprising a step of obtaining a dough by kneading a mixture material containing 15 to 80 parts by mass of a taste material, 5 to 45 parts by mass of vital gluten, 0.15 to 1.7 parts by mass of an emulsifier, and 20 to 90 parts by mass of water, per 100 parts by mass of at least one member selected from the group consisting of starch and wheat flour; a step of molding the dough into sticks; and a step of baking the resulting stick-shaped dough.
